(19) United States
(12) Patent Application Publication
(10) Pub. No.: US 2026/0301571 A1
(43) Pub. Date: Oct. 1, 2026

(54) METHOD OF PROVIDING PARKING LOT GUIDANCE SERVICE, VEHICLE TERMINAL THEREFOR, AND VEHICLE HAVING SAME

(71) Applicants: Hyundai Motor Company, Seoul (KR); Kia Corporation, Seoul (KR)

(72) Inventor: Min Woo LEE, Hwaseong-si (KR)

(73) Assignees: Hyundai Motor Company, Seoul (KR); Kia Corporation, Seoul (KR)

(21) Appl. No.: 19/365,554

(22) Filed: Oct. 22, 2025

(30) Foreign Application Priority Data
Mar. 28, 2025 (KR) 10-2025-0040444

(51) Int. Cl. G08G 1/14; G06Q 10/1093; G06Q 20/10; G07B 15/02

(52) U.S. Cl. CPC G08G 1/143; G06Q 10/1093; G06Q 20/102; G07B 15/02

(57) ABSTRACT

A method of providing parking lot guidance service that guides a user to a parking lot while considering a his or her schedule and remaining prepaid parking fee to improve the quality of parking-related services, a vehicle terminal therefor, and a vehicle including the same, may include determining, by a vehicle terminal, a destination parking lot for a scheduled location, which is a location related to a schedule, based on user's calendar information and vehicle's remaining parking information for a prepaid parking fee; and displaying, by the vehicle terminal, a driving route from a current location of the vehicle to the destination parking lot.

### CROSS REFERENCE TO RELATED APPLICATION

The present application claims priority to Korean Patent Application No. 10-2025-0040444, filed Mar. 28, 2025, the entire contents of which is incorporated herein for all purposes by this reference.

### TECHNICAL FIELD

The present disclosure relates to a parking lot guidance technology, and more specifically, to a method of providing parking lot guidance service that guides a user to a parking lot while considering a his or her schedule and remaining prepaid parking fee to improve the quality of parking-related services, a vehicle terminal therefor, and a vehicle having the same.

### BACKGROUND

When a customer utilizes a vehicle to visit a variety of locations, the customer may search for a space for parking (hereinafter, referred to as “parking lot”) every time he or she visits the location.

Furthermore, the customer must make payment for the use of the parking lot every time he or she utilizes the parking lot.

In the present way, since the customer must search for a parking lot and make payment every time he or she visits the location, the customer may feel inconvenienced and may be dissatisfied with the parking-related service.

Therefore, there is a need for a method of improving the quality of parking-related service.

The matters described as the background art are only for the purpose of improving the understanding of the background of the present disclosure, and should not be taken as acknowledging that they correspond to the related art already known to those skilled in the art.

### SUMMARY

The present disclosure provides a method of providing parking lot guidance service which may guide a user to a parking lot while considering a his or her schedule and remaining prepaid parking fee, a vehicle terminal therefor, and a vehicle having the same.

The present disclosure provides a method of providing a parking lot guidance service which may guide a user to an available parking lot based on a his or her schedule and remaining prepaid parking fee without paying an additional fee, a vehicle terminal therefor, and a vehicle having the same.

The technical objectives to be achieved in an exemplary embodiment of the present disclosure are not limited to the technical objectives mentioned above, and other technical objectives that are not mentioned may be clearly understood by a person having ordinary knowledge in the technical field to which the present disclosure belongs from the description below.

In order to achieve the above objectives, a method of providing parking guidance service according to an exemplary embodiment of the present disclosure may include determining, by a vehicle terminal, a destination parking lot for a scheduled location, which is a location related to a schedule, based on user's calendar information and vehicle's remaining parking information for a prepaid parking fee; and displaying, by the vehicle terminal, a driving route from a current location of the vehicle to the destination parking lot.

According to an exemplary embodiment of the present disclosure, the method of providing parking guidance service may further include determining, by the vehicle terminal, whether additional payment is required when the vehicle arrives at the destination parking lot; and performing, by the vehicle terminal, additional payment based on simple payment service, when it is determined that the additional payment is required.

According to an exemplary embodiment of the present disclosure, the determining of the destination parking lot may include determining a candidate parking lot for the scheduled location included in the calendar information; determining whether there is one or multiple candidate parking lots; and determining the candidate parking lot as the destination parking lot when it is determined that there is one candidate parking lot.

According to an exemplary embodiment of the present disclosure, the determining of the candidate parking lot may include checking a list of parking lots for the scheduled location included in the calendar information; and determining the candidate parking lot from the list of parking lots based on location information of the parking lots, location information of the scheduled location, and a start time of the schedule.

According to an exemplary embodiment of the present disclosure, the list of parking lots may be extracted from a parking payment history which is previously stored.

According to an exemplary embodiment of the present disclosure, the list of parking lots may be provided from a vehicle service server associated with the vehicle terminal.

According to an exemplary embodiment of the present disclosure, the determining of the candidate parking lot from the list of parking lots may include determining, as the candidate parking lot, a parking lot which is within walking distance from the parking lot to the scheduled location within the scheduled start time.

According to an exemplary embodiment of the present disclosure, the determining of the destination parking lot may include, when it is determined that there is a plurality of candidate parking lots, determining whether additional payment is required for the plurality of candidate parking lots; and determining one candidate parking lot of the plurality of candidate parking lots as the destination parking lot based on whether additional payment is required.

According to an exemplary embodiment of the present disclosure, the determining of whether additional payment is required is performed based on the remaining parking information, parking usage time information, and parking fee information.

According to an exemplary embodiment of the present disclosure, the determining of the destination parking lot based on whether additional payment is required may include, when the plurality of candidate parking lots include a candidate parking lot not requiring additional payment, determining the candidate parking lot not requiring additional payment as the destination parking lot.

According to an exemplary embodiment of the present disclosure, when there is a plurality of candidate parking lots not requiring additional payment, a candidate parking lot closest to the scheduled location among the plurality of candidate parking lots may be determined as the destination parking lot.

According to an exemplary embodiment of the present disclosure, the determining of the destination parking lot based on whether additional payment is required may include, when the plurality of candidate parking lots are candidate parking lots requiring additional payment, determining the candidate parking lots requiring additional payment as the destination parking lot.

According to an exemplary embodiment of the present disclosure, when there is a plurality of candidate parking lots requiring additional payment, the candidate parking lot requiring additional payment with the minimum additional payment may be determined as the destination parking lot.

According to an exemplary embodiment of the present disclosure, the calendar information may be stored in the vehicle terminal.

According to an exemplary embodiment of the present disclosure, the calendar information may be provided from a user terminal associated with the vehicle terminal.

A vehicle terminal according to an exemplary embodiment of the present disclosure may be disposed in a vehicle, and be configured to determine a destination parking lot for a scheduled location, which is a location related to a schedule, based on user's calendar information and vehicle's remaining parking information for a prepaid parking fee; and display a driving route from a current location of the vehicle to the destination parking lot.

According to an exemplary embodiment of the present disclosure, the vehicle terminal may include a communication module including a communication circuit configured to communicate with a server associated with the vehicle terminal; and a processor configured to determine the destination parking lot for the scheduled location based on the calendar information and the remaining parking information, and to display a driving route from the current location of the vehicle to the destination parking lot.

According to an exemplary embodiment of the present disclosure, the communication module may receive a list of parking lots related to the scheduled location from the server.

According to an exemplary embodiment of the present disclosure, when the vehicle arrives at the destination parking lot, the processor is configured to determine whether additional payment is required, and when it is determined that the additional payment is required, perform additional payment based on a simple payment service.

A vehicle according to an exemplary embodiment of the present disclosure is disposed with a vehicle terminal, in which the vehicle terminal may be configured to determine a destination parking lot for a scheduled location, which is a location related to a schedule, based on user's calendar information and vehicle's remaining parking information for a prepaid parking fee; and display a driving route from a current location of the vehicle to the destination parking lot.

Specific details according to various examples of the present disclosure other than the means for solving the objectives mentioned above are included in the description and drawings below.

According to an exemplary embodiment of the present disclosure, a method of providing a parking lot guidance service which may guide a user to a parking lot while considering a his or her schedule and remaining prepaid parking fee, a vehicle terminal therefor, and a vehicle having the same may be provided.

According to an exemplary embodiment of the present disclosure, a method of providing a parking lot guidance service which may guide a user to an available parking lot based on a his or her schedule and remaining prepaid parking fee without paying an additional fee, a vehicle terminal for the same, and a vehicle having the same may be provided.

When the method of providing a parking lot guidance service according to an exemplary embodiment of the present disclosure is applied to a vehicle, a user may not search for a parking lot and pay a cost every time he or she visits a location.

Therefore, the quality of parking-related services may be improved, and customer satisfaction may be improved by eliminating the inconvenience felt by a user when parking.

The effect obtained in the present disclosure is not limited to the above-mentioned effects, and other effects not mentioned above may be clearly understood by those skilled in the art from the following description.

### BRIEF DESCRIPTION OF THE DRAWINGS

The above and other objects, features, and other advantages of the present disclosure will be more clearly understood from the following detailed description when taken in conjunction with the accompanying drawings, in which:

FIG. 1 is a drawing illustrating an example of a system for implementing a method of providing a parking lot guidance service, according to an exemplary embodiment of the present disclosure.

FIG. 2 is a drawing illustrating an example of a configuration of a vehicle terminal, according to an exemplary embodiment of the present disclosure.

FIG. 3 is a drawing illustrating an example of a configuration of a vehicle service server, according to an exemplary embodiment of the present disclosure.

FIG. 4 is a drawing illustrating a method of providing parking lot guidance service, according to an exemplary embodiment of the present disclosure.

FIG. 5 and FIG. 6 are drawings specifically illustrating a destination parking lot determination operation S410 of FIG. 4.

### DETAILED DESCRIPTION OF THE DISCLOSURE

In describing the embodiments disclosed in this specification, when it is determined that a specific description of related known technology may obscure the gist of the embodiments disclosed in this specification, the detailed description thereof will be omitted. In addition, the attached drawings are only intended to facilitate easy understanding of the embodiments disclosed in this specification, and the technical ideas disclosed in this specification are not limited by the attached drawings, and should be understood to include all modifications, equivalents, or substitutes included in the ideas and technical scope of the present disclosure.

Although terms including ordinal numbers such as first, second, etc. may be used to describe various components, the components are not limited by the terms. The terms are used only for distinguishing one component from another.

The singular expression includes the plural expression unless the context clearly indicates otherwise.

In the present specification, it should be understood that the terms “include” or “have” are intended to specify the presence of a feature, number, step, operation, component, part, or combination thereof described in the specification, but do not exclude in advance the possibility of the presence or addition of one or more other features, numbers, steps, operations, components, parts, or combinations thereof.

The terms “module” and “part” used for components in the following description are provided or used interchangeably only for the convenience of writing the specification, and do not have distinct meanings or roles in themselves.

When a component is referred to as being “coupled” or “connected” to another component, it should be understood that it may be directly coupled or connected to the other component, but that there may be other components in between. On the other hand, when a component is referred to as being “directly coupled” or “directly connected” to another component, it should be understood that there are no other components in between.

Furthermore, a unit or control unit included in the name is a term widely used in naming a control device (controller) that is configured to control a specific function of a vehicle, and does not mean a generic function unit.

A controller may include a communication device that communicates with other controllers or sensors to control the function in charge, a memory that stores an operating system or logic commands and input/output information, and one or more processors that perform judgments, calculations, decisions, etc. necessary for controlling the function in charge.

Any number of components or various components in any of the configurations described in the present specification may be included in the disclosure described in the present specification. The components may include any combination of the features described in the present specification and may be provided in any of the various configurations described in the present specification. The concepts regarding the structure and arrangement of the components of the present disclosure as well as their use and operation may be applied to any number of embodiments in any combination as well as to the specific embodiments discussed in the present specification. Embodiments including those having various features in various arrangements are described below with reference to the drawings.

Hereinafter, various embodiments disclosed in the present specification will be described in detail with reference to the attached drawings. Regardless of the drawing numbers, identical or similar components are provided the same reference numbers and redundant descriptions thereof will be omitted.

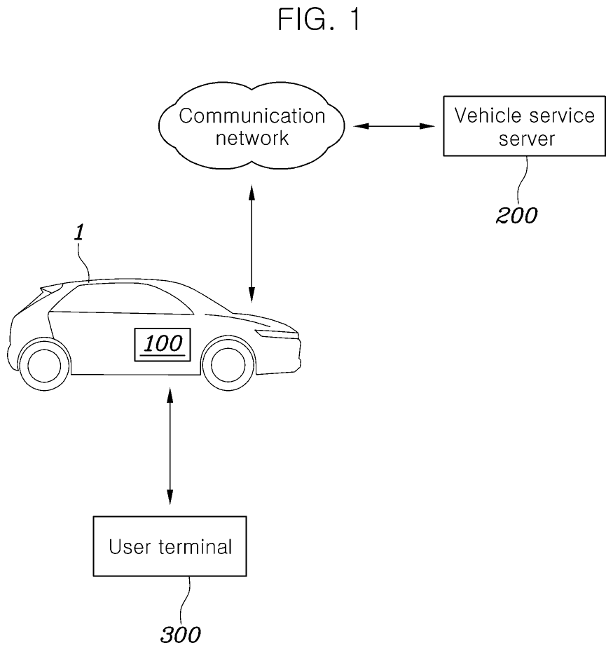

FIG. 1 is a drawing illustrating an example of a system for implementing a method of providing parking lot guidance service, according to an exemplary embodiment of the present disclosure.

Referring to FIG. 1, a system for providing parking lot guidance service according to an exemplary embodiment of the present disclosure may include a vehicle terminal 100 disposed in a vehicle 1, and a server 200 which is associated with the vehicle terminal 100 via a communication network to provide a vehicle-related service (hereinafter, referred to as “vehicle service server”).

According to an exemplary embodiment of the present disclosure, the system for providing the parking lot guidance service may further include a user terminal 300. However, the configuration of the system for providing the parking lot guidance service is not limited to FIG. 1.

The vehicle terminal 100 and a vehicle service server 200 may be implemented to provide a connected car service (CCS). According to an exemplary embodiment of the present disclosure, the vehicle terminal 100 and the vehicle service server 200 may be implemented to provide a parking-related service.

In an exemplary embodiment of the present disclosure, the vehicle terminal 100 and the vehicle service server 200 may be implemented to provide a simple payment (In Car Payment) service. For example, the simple payment service may include a parking-related payment service.

In an exemplary embodiment of the present disclosure, the vehicle terminal 100 and the vehicle service server 200 may be implemented to provide navigation service. For example, the navigation service may include the parking lot guidance service based on the user's calendar information.

For example, the vehicle terminal 100 may implement an infotainment system of the vehicle 1 (In-Vehicle Infotainment). For example, the vehicle terminal 100 may be implemented as an Audio Video Navigation (AVN) system, an Audio Video Navigation Telecommunication (AVNT) system, a cluster, a head up display, etc.

For example, the vehicle terminal 100 and the vehicle service server 200 may perform communication over a preset communication network. For example, wireless Internet technologies such as Wireless LAN (WLAN)(Wi-Fi), Wireless Broadband (WiBro), and/or Worldwide Interoperability for Microwave Access (WiMAX), and/or mobile communication technologies such as Code Division Multiple Access (CDMA), Global System for Mobile communication (GSM), Long Term Evolution (LTE), LTE-Advanced, and/or International Mobile Telecommunication (IMT)-2020 may be used as the communication network.

According to an exemplary embodiment of the present disclosure, the user terminal 300 may provide registered calendar information to the vehicle terminal 100. For example, the calendar information may include the user's schedule information. For example, the schedule information may include location information and time information. For example, the location information may be expressed as scheduled location information, and the time information may be expressed as scheduled time information. In an exemplary embodiment of the present disclosure, the calendar information may be understood to include the scheduled location information and the scheduled time information.

For example, the vehicle terminal 100 and the user terminal 300 may perform communication over a short-range communication network. For example, the short-range communication technologies may include Bluetooth, ZigBee, Ultra Wideband (UWB), Radio Frequency Identification (RFID), Infrared Data Association (IrDA), etc.

### Vehicle Terminal 100

For example, when the vehicle terminal 100 enters a route guidance mode, it may provide the parking lot guidance service according to an exemplary embodiment of the present disclosure. For example, the vehicle terminal 100 may display a user setting menu (USM), and enter the route guidance mode when the route guidance mode is selected from the user setting menu (USM).

According to an exemplary embodiment of the present disclosure, the vehicle terminal 100 may be configured to determine a space capable of parking (hereinafter, a parking lot) related to a place to be visited according to a schedule (hereinafter, a scheduled location) based on calendar information and remaining parking information.

For example, the remaining parking information may include remaining prepaid parking fee information and remaining parking time information.

For example, the calendar information may be calendar information registered in the vehicle terminal 100. For example, the calendar information may be calendar information provided from the user terminal 300.

According to an exemplary embodiment of the present disclosure, the vehicle terminal 100 may extract a list of parking lots related to the corresponding scheduled location based on previously stored parking payment history.

According to an exemplary embodiment of the present disclosure, when the vehicle terminal 100 has no previously stored parking payment history related to a scheduled location, the vehicle terminal 100 may communicate with the vehicle service server 200 to receive a list of parking lots around the scheduled location For example, the list of parking lots may include location information and parking fee information for each parking lot, but the information included in the list of parking lots is not limited thereto.

According to an exemplary embodiment of the present disclosure, the vehicle terminal 100 may determine, as the candidate parking lot, a parking lot which is within walking distance from the parking lot to the scheduled location within the scheduled start time, among the list of parking lots. Here, the certain time may mean a certain start time.

According to an exemplary embodiment of the present disclosure, when there is one candidate parking lot, the vehicle terminal 100 may be configured to determine the candidate parking lot as the destination parking lot.

According to an exemplary embodiment of the present disclosure, when there is a plurality of candidate parking lots, the vehicle terminal 100 may store a list of candidate parking lots.

According to an exemplary embodiment of the present disclosure, the vehicle terminal 100 may be configured to determine whether additional payment occurs when using parking lots included in the list of candidate parking lots.

For example, the vehicle terminal 100 may be configured to determine whether additional payment occurs based on remaining parking information, parking usage time information, and parking cost information.

For example, the parking usage time information may be input by the user.

For example, the parking usage time information may be determined based on the expected arrival time at the parking lot, the end time of the schedule, and the walking time between the scheduled location and the parking lot.

According to an exemplary embodiment of the present disclosure, the vehicle terminal 100 may be configured to determine a parking lot where additional payment does not occur as the destination parking lot.

In the case where there is a plurality of parking lots where additional payment does not occur, the vehicle terminal 100 may be configured to determine the parking lot closest to the scheduled location as the destination parking lot.

According to an exemplary embodiment of the present disclosure, when additional payment occurs, the vehicle terminal 100 may be configured to determine the parking lot available at the minimum additional fee as the destination parking lot.

When the vehicle terminal 100 determines the destination parking lot, it may determine the driving route from the current location of the vehicle 1 to the destination parking lot and guide the determined driving route.

When the vehicle 1 arrives at the destination parking lot, the vehicle terminal 100 may pay the additional fee based on the simple payment (In Car Payment) service when additional payment is required.

When additional payment does not occur, the vehicle terminal 100 may guide the vehicle 1 to the parking lot without additional payment.

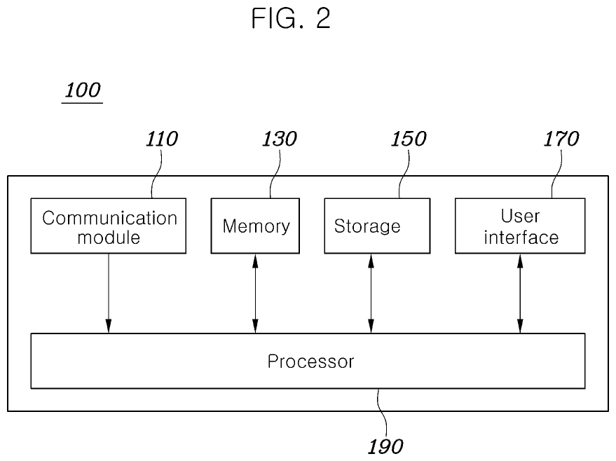

FIG. 2 is a drawing illustrating an example of a configuration of a vehicle terminal 100, according to an exemplary embodiment of the present disclosure.

Referring to FIG. 2, the vehicle terminal 100 may include a communication module 110, a memory 130, a storage 150, a user interface 170, and a processor 190, but the configuration of the vehicle terminal 100 is not limited thereto.

The communication module 110 may include a communication circuit implemented to communicate with a vehicle service server 200 over a preset communication network. According to an exemplary embodiment of the present disclosure, the communication module 110 may include a communication circuit implemented to communicate with a sensor and controller of the vehicle 1 based on a preset vehicle communication protocol.

For example, the vehicle communication protocol may include Local Interconnect Network (LIN), Controller Area Network (CAN), FlexRay, Ethernet, etc., but the type of the vehicle communication protocol is not limited thereto.

Information received by the communication module 110 may be stored in the memory 130, may be stored in the storage 150, and may be transmitted to the processor 190.

The memory 130 may store algorithms (or software or programs), data, etc. required for the vehicle terminal 100 to perform its function. For example, the memory 130 may store algorithms, data, etc. required for the vehicle terminal 100 to perform the method of providing the parking lot guidance service, according to the exemplary embodiment of the present disclosure.

The storage 150 may store information generated or obtained according to the operation of the vehicle terminal 100. For example, the storage 150 may store parking payment history, remaining parking information, user calendar information, etc.

For example, the memory 130 and storage 150 may be implemented as at least one of storage media (or recording media) such as a flash memory, a hard disk, a Secure Digital Card (SD card), a Random Access Memory (RAM), a Static Random Access Memory (SRAM), a Read Only Memory (ROM), a Programmable Read Only Memory (PROM), an Electrically Erasable and Programmable ROM (EEPROM), an Erasable and Programmable ROM (EPROM), a register, a removable disk, and a web storage.

The user interface 170 may be implemented to receive user instructions. For example, the user interface 170 may display a graphical user interface (GUI). For example, the user interface 170 may display a user setting menu (USM).

The user interface 170 may be implemented to output or display various types of information. For example, the user interface 170 may include a speaker, a display device, etc. For example, the display device may include at least one of a liquid crystal display (LCD), a thin film transistor-liquid crystal display (TFT LCD), an organic light-emitting diode (OLED), a flexible display, and a three-dimensional display (3D display), but the type of display implementing the display device is not limited thereto.

According to an exemplary embodiment of the present disclosure, the user interface 170 may display a driving route for navigation service of the vehicle 1. According to an exemplary embodiment of the present disclosure, the user interface 170 may display information related to parking lot guidance.

The processor 190 may perform the overall operation of the vehicle terminal 100. The processor 190 may provide the parking lot guidance service for the vehicle 1 based on information or signals received through the communication module 110, algorithms/data stored in the memory 130, information stored in the storage 150, instructions or information input through the user interface 170, etc.

To the present end, the processor 190 may be a data processing device implemented as hardware with a circuit including a physical structure for executing desired operations. For example, the desired operations may include code or instructions included in a program. For example, the data processing device implemented in hardware may include a microprocessor, a central processing unit, a processor core, a multi-core processor, a multiprocessor, an application-specific integrated circuit (ASIC), or a field programmable gate array (FPGA).

### Vehicle Service Server 200

The vehicle service server 200 may provide vehicle-related services. In an exemplary embodiment of the present disclosure, the vehicle service server 200 may be communicated with the vehicle terminal 100 of the vehicle 1 to provide vehicle-related services. For example, the vehicle service server 200 may be referred to as a “connected car server”, etc.

According to an exemplary embodiment of the present disclosure, the vehicle service server 200 may be communicated with the vehicle terminal 100 to provide a navigation service (or route guidance service), a parking guidance service (including a parking lot guidance service), a simple payment service, etc.

According to an exemplary embodiment of the present disclosure, when the vehicle service server 200 receives a request for parking lot information for a location from the vehicle terminal 100, the vehicle service server 200 may provide a list of parking lots around the location to the vehicle terminal 100.

For example, the vehicle service server 200 may be formed as a single structure, or may be formed as a multi-structure including a plurality of sub-servers.

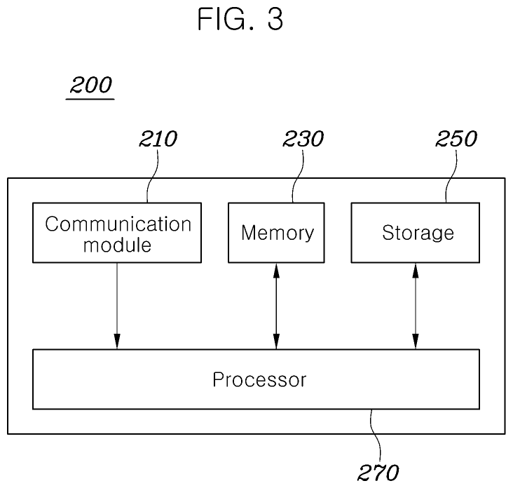

FIG. 3 is a diagram illustrating an example of the configuration of a vehicle service server 200, according to an exemplary embodiment of the present disclosure.

Referring to FIG. 3, the vehicle service server 200 may include a communication module 210, a memory 230, a storage 250, and a processor 270, but the configuration of the vehicle service server 200 is not limited thereto. For example, the vehicle service server 200 may further include a separate database.

The communication module 210 may include a communication circuit implemented to communicate with the vehicle 1 over a preset communication network.

Information received by the communication module 210 may be stored in the storage 250, transmitted to the processor 270, and then stored in a separate database.

The memory 230 may store algorithms (or software or programs), data, etc. required for the vehicle service server 200 to perform its functions. For example, the memory 230 may store algorithms, data, etc. required for the vehicle service server 200 to provide connected car services, such as navigation services (or route guidance services), parking guidance services (including parking lot guidance services), and easy payment services.

The storage 250 may store information generated or obtained according to the operation of the vehicle service server 200.

For example, the memory 230 and the storage 250 may be implemented as at least one or more of storage media (or recording media), such as a flash memory, a hard disk, a Secure Digital Card (SD card), a Random Access Memory (RAM), a Static Random Access Memory (SRAM), a Read Only Memory (ROM), a Programmable Read Only Memory (PROM), an Electrically Erasable and Programmable ROM (EEPROM), an Erasable and Programmable ROM (EPROM), a register, a removable disk, and a web storage.

The processor 270 may perform the overall operation of the vehicle service server 200. The processor 270 may provide a connected car service for the vehicle 1 based on information or signals received through the communication module 210, algorithms/data stored in the memory 230, information stored in the storage 250, information stored in a separate database, etc.

To the present end, the processor 270 may be a hardware-implemented data processing device with a circuit including a physical structure for executing desired operations. For example, the desired operations may include code or instructions included in a program. For example, the hardware-implemented data processing device may include a microprocessor, a central processing unit, a processor core, a multi-core processor, a multiprocessor, an Application-Specific Integrated Circuit (ASIC), and a Field Programmable Gate Array (FPGA).

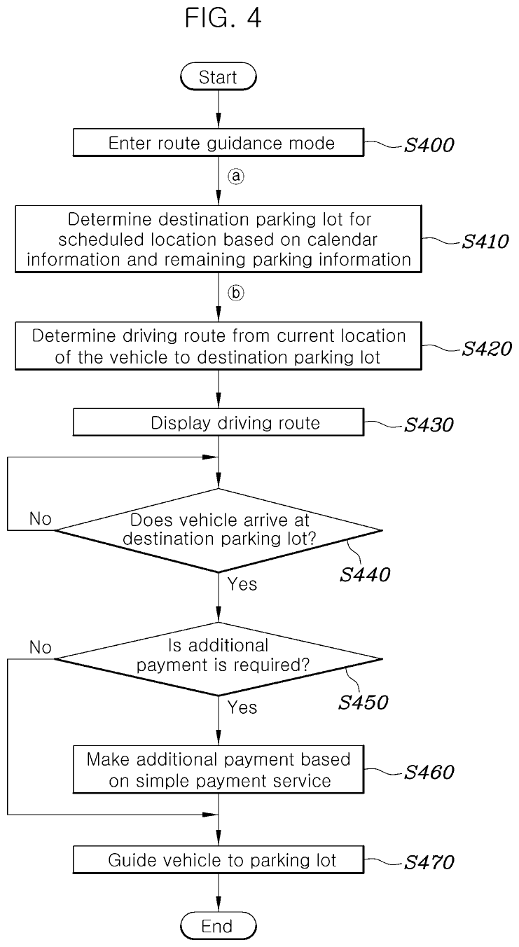

FIG. 4 is a drawing illustrating a method of providing a parking lot guidance service, according to an exemplary embodiment of the present disclosure.

The step-by-step operation illustrated in FIG. 4 may be performed by the vehicle terminal 100 described with reference to FIGS. 1 and 2.

Referring to FIGS. 1 to 3, the vehicle terminal 100 may enter a route guidance mode based on a user's command (S400).

For example, the user's command may be input in a user setting menu (USM) displayed on the vehicle terminal 100.

The vehicle terminal 100 may be configured to determine a destination parking lot for the scheduled location based on calendar information and remaining parking information (S410).

Thereafter, the vehicle terminal 100 may be configured to determine a driving route from the current location of the vehicle 1 to the destination parking lot (S420), and display the determined driving route (S430).

For example, the vehicle terminal 100 may display the determined destination parking lot and driving route, and perform guidance based on the driving route, when the user selects the destination parking lot and the driving route.

The vehicle terminal 100 may continuously display and guide the driving route until the vehicle 1 arrives at the destination parking lot.

In the case that the vehicle 1 arrives at the destination parking lot (S440—Yes), when additional payment is required (S450—Yes), the vehicle terminal 100 may make the additional payment based on the simple payment (In Car Payment) service (S460) and then guide the vehicle 1 to the parking lot (S470).

When additional payment is not required (S450—No), the vehicle terminal 100 may guide the vehicle 1 to the parking lot without additional payment (S470).

According to an exemplary embodiment of the present disclosure, the vehicle terminal 100 may be configured to determine whether additional payment is required based on remaining parking information, parking usage time information, and parking cost information.

For example, the parking usage time information may be entered by the user. For example, the parking usage time information may be determined based on the expected arrival time of the parking lot, the end time of the schedule, and the travel time between the scheduled location and the parking lot.

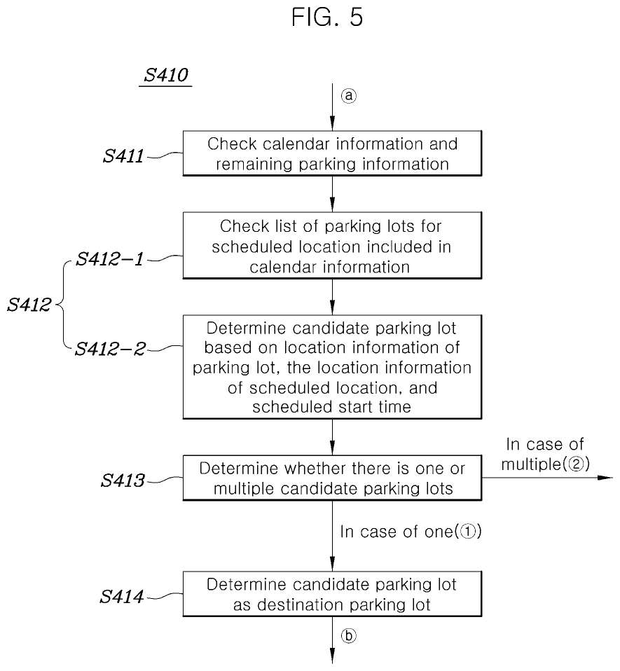

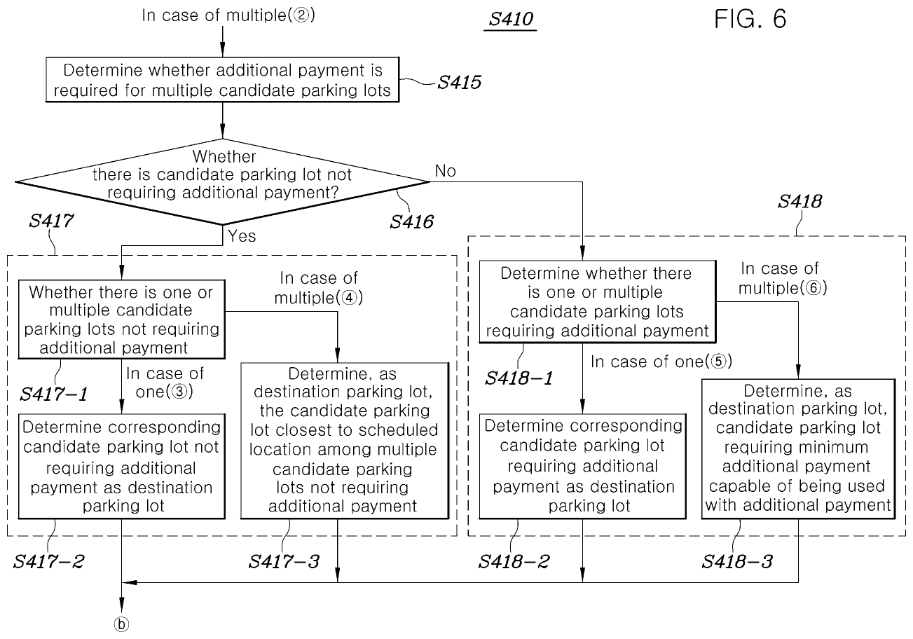

FIG. 5 and FIG. 6 are drawings specifically illustrating the destination parking lot determination operation (S410) of FIG. 4.

Referring to FIG. 5 and FIG. 6, the vehicle terminal 100 may check calendar information and remaining parking information (S411).

Thereafter, the vehicle terminal 100 may be configured to determine a candidate parking lot for the scheduled location included in the calendar information (S412).

The vehicle terminal 100 may check a list of parking lots for the scheduled location included in the calendar information (S412-1).

For example, the list of parking lots may be extracted from the previously stored parking payment history. For example, the list of parking lots may be provided from the vehicle service server 200.

For example, the list of parking lots includes location information and parking fee information for each parking lot.

Thereafter, the vehicle terminal 100 may be configured to determine a candidate parking lot from the list of parking lots based on the location information of the parking lot, the location information of the scheduled location, and the scheduled start time (S412-2).

For example, the vehicle terminal 100 may determine, as a candidate parking lot, a parking lot which is within walking distance from the parking lot to the scheduled location within the start time of the schedule.

After operation S412, the vehicle terminal 100 may be configured to determine whether there is one or a plurality of candidate parking lots (S413).

When there is only one candidate parking lot (\textcircled{1}), the vehicle terminal 100 may be configured to determine the candidate parking lot as the destination parking lot (S414).

When there is a plurality of candidate parking lots (\textcircled{2}), the vehicle terminal 100 may be configured to determine whether additional payment is required for the plurality of candidate parking lots when using them (S415).

For example, the vehicle terminal 100 may be configured to determine whether additional payment is required based on remaining parking information, parking usage time information, and parking cost information.

For example, the parking usage time information may be entered by the user. For example, the parking usage time information may be determined based on the expected arrival time of the parking lot, the end time of the schedule, and the travel time between the scheduled location and the parking lot.

After operation S415, the vehicle terminal 100 may be configured to determine whether there is a candidate parking lot not requiring additional payment (S416).

When there is a candidate parking lot not requiring additional payment (S416—Yes), the vehicle terminal 100 may be configured to determine the candidate parking lot not requiring additional payment as the destination parking lot (S417).

The vehicle terminal 100 may be configured to determine whether there is one or a plurality of candidate parking lots not requiring additional payment (S417-1).

When there is only one candidate parking lot not requiring additional payment (\textcircled{3}), the vehicle terminal 100 may be configured to determine the corresponding candidate parking lot not requiring additional payment as the destination parking lot (S417-2).

If there is a plurality of candidate parking lots not requiring additional payment (\textcircled{4}), the vehicle terminal 100 may determine, as the destination parking lot, the candidate parking lot closest to the scheduled location among the plurality of candidate parking lots not requiring additional payment (S417-3).

When there is no candidate parking lot requiring additional payment (S416—No), that is, when there is only a candidate parking lot requiring additional payment, the vehicle terminal 100 may be configured to determine the candidate parking lot requiring additional payment as the destination parking lot (S418).

The vehicle terminal 100 may be configured to determine whether there is one or a plurality of candidate parking lots requiring additional payment (S418-1).

When there is only one candidate parking lot requiring additional payment (\textcircled{5}), the vehicle terminal 100 may be configured to determine the corresponding candidate parking lot requiring additional payment as the destination parking lot (S418-2).

When there is a plurality of candidate parking lots requiring additional payment (\textcircled{6}), the vehicle terminal 100 may determine, as the destination parking lot, the candidate parking lot requiring minimum additional payment capable of being used with additional payment (S418-3).

While the disclosure has been shown and described with respect to exemplary embodiments, it will be apparent to those skilled in the art that the present disclosure has been variously modified and changed without departing from the spirit of the disclosure provided by the following claims.

What is claimed is:

1. A method of providing parking guidance service, the method comprising:
determining, by a vehicle terminal, a destination parking lot for a scheduled location, which is a location related to a schedule, based on user's calendar information and vehicle's remaining parking information for a prepaid parking fee; and
displaying, by the vehicle terminal, a driving route from a current location of the vehicle to the destination parking lot.

2. The method of claim 1, further comprising:
determining, by the vehicle terminal, whether additional payment is required based on that the vehicle arrives at the destination parking lot; and
performing, by the vehicle terminal, the additional payment based on simple payment service, based on that it is determined that the additional payment is required.

3. The method of claim 1, wherein the determining of the destination parking lot comprises:
determining a candidate parking lot for the scheduled location included in the calendar information;
determining whether there is one or a plurality of candidate parking lots; and
determining the candidate parking lot as the destination parking lot based on that it is determined that there is one candidate parking lot.

4. The method of claim 3, wherein the determining of the candidate parking lot comprises:
checking a list of parking lots for the scheduled location included in the calendar information; and
determining the candidate parking lot from the list of parking lots based on location information of the parking lots, location information of the scheduled location, and a start time of the schedule.

5. The method of claim 4, wherein the list of parking lots is extracted from a parking payment history which is previously stored.

6. The method of claim 4, wherein the list of parking lots is provided from a vehicle service server associated with the vehicle terminal.

7. The method of claim 4, wherein the determining of the candidate parking lot from the list of parking lots comprises determining, as the candidate parking lot, a parking lot which is within walking distance from the parking lot to the scheduled location within the scheduled start time.

8. The method of claim 3, wherein the determining of the destination parking lot comprises:
based on that it is determined that there is the plurality of candidate parking lots, determining whether additional payment is required for the plurality of candidate parking lots; and
determining one candidate parking lot of the plurality of candidate parking lots as the destination parking lot based on whether the additional payment is required.

9. The method of claim 8, wherein the determining of whether the additional payment is required is performed based on the remaining parking information, parking usage time information, and parking fee information.

10. The method of claim 8, wherein the determining of the destination parking lot based on whether the additional payment is required comprises:
based on that the plurality of candidate parking lots include a candidate parking lot not requiring the additional payment, determining the candidate parking lot not requiring the additional payment as the destination parking lot.

11. The method of claim 10, wherein based on that there is a plurality of candidate parking lots not requiring the additional payment, a candidate parking lot closest to the scheduled location among the plurality of candidate parking lots is determined as the destination parking lot.

12. The method of claim 8, wherein the determining of the destination parking lot based on whether the additional payment is required comprises:
based on that the plurality of candidate parking lots are candidate parking lots requiring the additional payment, determining the candidate parking lots requiring the additional payment as the destination parking lot.

13. The method of claim 12, wherein based on that there is the plurality of candidate parking lots requiring the additional payment, the candidate parking lot requiring the additional payment with a minimum additional payment is determined as the destination parking lot.

14. The method of claim 1, wherein the calendar information is stored in the vehicle terminal.

15. The method of claim 1, wherein the calendar information is provided from a user terminal associated with the vehicle terminal.

16. A vehicle terminal disposed in a vehicle, wherein the vehicle terminal is configured to:
determine a destination parking lot for a scheduled location, which is a location related to a schedule, based on user's calendar information and vehicle's remaining parking information for a prepaid parking fee; and
display a driving route from a current location of the vehicle to the destination parking lot.

17. The vehicle terminal of claim 16, wherein the vehicle terminal comprises:
a communication module including a communication circuit configured to communicate with a server associated with the vehicle terminal; and
a processor configured to determine the destination parking lot for the scheduled location based on the calendar information and the remaining parking information, and to display a driving route from the current location of the vehicle to the destination parking lot.

18. The vehicle terminal of claim 17, wherein the communication module receives a list of parking lots related to the scheduled location from the server.

19. The vehicle terminal of claim 17, wherein based on that the vehicle arrives at the destination parking lot, the processor is configured to determine whether additional payment is required, and based on that it is determined that the additional payment is required, is configured to perform the additional payment based on a simple payment service.

20. A vehicle comprising a vehicle terminal, wherein the vehicle terminal is configured to:
determine a destination parking lot for a scheduled location, which is a location related to a schedule, based on user's calendar information and vehicle's remaining parking information for a prepaid parking fee; and
display a driving route from a current location of the vehicle to the destination parking lot.
